(19) United States
(12) Patent Application Publication
(10) Pub. No.: US 2013/0145690 A1
(43) Pub. Date: Jun. 13, 2013

(54) HORTICULTURAL APPARATUS AND METHOD

(71) Applicant: Sterling L. Cannon, Columbus, GA (US)

(72) Inventor: Sterling L. Cannon, Columbus, GA (US)

(21) Appl. No.: 13/323,900

(22) Filed: Dec. 13, 2011

(51) Int. Cl. A01G 9/02

(52) U.S. Cl. 47/66.7; 47/82

(57) ABSTRACT

In a preferred embodiment, a freestanding vertical horticultural apparatus for commercial and/or home use for growing of plants in containers includes a plurality of containers arranged in a plurality of mutually vertically spaced groups which are rotatably supported in brackets by an elongated vertical spindle through which is routed a pressurized fluid supply line which is coupled to a spray emitter by way of a flow adjustment valve. At a flow rate determined by the valve, the emitter sprays irrigation fluid inside a hollow distributor body positioned at the top of the apparatus. The lower portion of the distributor body is segmented into a plurality of sumps, each of which feeds a substantially uniform quantity of the fluid under gravity to each respective one of the containers by way of a respective fluid delivery tube, one of which is coupled to the lower portion of each sump.

### CROSS-REFERENCE TO RELATED APPLICATIONS

Not Applicable.

### STATEMENT REGARDING FEDERALLY SPONSORED-RESEARCH OR DEVELOPMENT

Not Applicable.

### INCORPORATION BY REFERENCE

Not Applicable.

### FIELD OF THE INVENTION

The invention relates to the field of horticulture. More particularly, the present invention relates to a horticultural apparatus for commercial and/or home use for growing of plants in containers arranged in a plurality of mutually vertically spaced groups which are rotatably supported in brackets by an elongated spindle through which is routed a pressurized fluid supply line which is coupled to a sprayer which discharges irrigation fluid inside a hollow distributor body whose lower portion is segmented into a plurality of sumps each of which feeds a substantially uniform quantity of the fluid under gravity to a respective one of the containers.

### BACKGROUND OF THE INVENTION

Because they make extended amounts of space above ground level, or floor level, available for plant production, vertically stacked plant growing systems are an effective way of increasing the plant yield per unit area of ground or floor space available for growing plants or crops. Such systems are also capable of providing lush vertical arrays of flowering or non-flowing plants which can be very attractive in appearance. When used for the production of vegetables or other crops, elevation of the plants also provides improved ergonomics for safe, fast and efficient harvesting as well as elevating the fruit or vegetables to avoid contact with the ground in order to help deter rot and insect infestation. Various types of vertically stacked plant growing systems are known in the prior art, of which the following are but a few examples.

U.S. Pat. No. 4,419,843 to Johnson, Sr. discloses a self-irrigating, multi-tier vertical planter having a pan-shaped base within which is mounted an upstanding tubular post member. A plurality of trays, each having a radial V-shaped cross section for containing soil or other organic growing medium, are vertically stacked on one another and secured to the post member overlying the pan-shaped base. Each of the trays has a series of apertures at its lowest point to allow irrigating liquid to seep into the tray below. A second series of apertures is provided in the outer inclined wall to allow excess liquid to drip into a lower tray or into the base. A pipe mounted in the support tube carries irrigating liquid to a sprinkler manifold which is sprinkled down onto the trays below.

U.S. Pat. No. 6,612,073 to Powell et al. discloses an intensive plant growing stacking container system which includes a plurality of molded, stackable containers having multiple, mutually angularly spaced, lobes which can nest inside one another for efficient shipping and storage. Each container has a plurality of drain openings in its bottom and incorporates a number of support protrusions that fit into support openings on the top of the second container to provide vertical alignment and lateral stability when the containers are assembled in a stack for use each container includes a central opening through which may pass the pipe for providing both mechanical support and irrigation liquid to the top of the stack. The lobes of the containers and support protrusions are arranged so that when the containers are assembled into a stack, the lobes of containers are alternatingly arranged. According to this arrangement, instead of all lobes in the stack being aligned vertically with one immediately atop another, the lobes of containers which lie immediately vertically adjacent to one another in the stack are angularly offset from one another. This provides room for plant growth with minimal interference or light blockage from lobes on the level of the stack lying immediately above.

U.S. Pat. No. 5,309,761 to Byun discloses stack type plant pots which are divided into radially extending pot portions by means of vertical partitions. The pot portions are generally shaped like a cone or funnel and have drain openings at their bottom. The pots can be stacked one upon another so that the pot portions form a vertically alternating arrangement similar to that described above in connection with Powell et al. '073. To provide for taller plants, or to alter the appearance of the stack, distance adjusting members which can be interposed between pots to adjust the vertical distance between the pots in the stack.

U.S. Pat. No. 6,840,008 to Bullock et al. discloses a vertical planting system having a plurality of growing containers formed of expanded polystyrene foam. Each container has an unpartitioned interior having a generally flat bottom which is provided with a plurality of drainage holes and a central support tube receiving aperture. Located at the corners each container are four planting areas each of which is in the general shape of a cone or funnel. The walls of the containers have alignment cavities and pins which enable the containers to be stacked on top of one another with the support pole running vertically upwardly up through the central apertures of the containers. The support pole terminates in a T-fitting which connects to a water supply. A water diffuser box is supported below the T-fitting on top of the top container of the stack and receives irrigation water from the water supply. The bottom of the diffuser box includes a plurality of drainage apertures which discharge water into the top of the top container in the stack. Whatever portion, if any, of that water is not absorbed by the growing media in the top container passes through the post receiving aperture and/or the drainage holes in the bottom of the top container and is discharged into the top of the container lying immediately below the top container. Unabsorbed water passes downwardly through the stack from one container to the next immediately lower container in the stack in the same manner until, after being discharged from the lowest container, any remaining fluid is received in a fluid collector.

The foregoing and other prior art vertical plant growing devices of which Applicant's is aware are subject to one or more of a number of problems. All are prone to uneven distribution of fluid to the individual containers in the stack. Conventional planters that are irrigated by gravity-fed fluid supply lines, particularly those on large commercial operations, are subject to large variations in fluid delivery due to pressure fluctuations caused by factors such as the variations in flow resistance due to fluid supply lines of varying length, or placement of planters at different base elevations. In some cases, placement of planters on a base grade which varies by as little as two to three degrees (2° to 3°) results in unacceptable variation in the amount of irrigation fluid delivered to the plants. This precludes use of much land which might otherwise be well-suited to horticultural production or requires expensive and potentially environmentally damaging grading operations to be carried out to level the land.

Achieving acceptable fluid distribution in some prior art vertical planting systems is unduly dependant on precise leveling of the containers and/or the wicking properties of the plant growing media used. Even slight tilting of the containers can sometimes result in establishment of preferential flow paths that tend to over-irrigate some plants while depriving others. If the growing media is not sufficiently absorbent, fluid will pass too easily to lower levels leaving upper levels insufficiently irrigated. On the other hand, if the growing media is too absorbent, lower levels receive too little fluid while upper levels retain too much.

In prior art systems of the type that use a vertical support rod where the rod is in intimate contact with the growing media, there is a tendency for the rod to clear a fluid path of least fluid flow resistance through the container, thereby allowing fluid to bypass the growing media. Some prior art vertical plant growing devices, require fluid from higher containers to drip onto plants in the lower containers. Some fluids may be harmful when applied to leaves and blossoms. Also, plant foliage may deflect fluids away from the container intended to receive them, allowing them instead to be wasted, falling uselessly to the ground.

Some prior art planter systems, especially those which are irrigated under gravity, require use of overhead piping. Such piping not only requires support structures which can be costly and time consuming to erect but can also cast a shadow on plants and interfere with the passage of personnel and equipment between rows or columns of planters.

In prior art planters of the type in which fluid flows successively from higher containers to lower ones, nutrient solution introduced into upper containers is subject to a drop in the nutrient concentration as each successive root ball absorbs some of the nutrient. Thus, the bottommost containers, which may already be at a disadvantage with respect to light exposure, are disadvantaged further because they receive lower concentrations of nutrients than containers at higher levels in the planter. It has also been observed by the inventor that the pH of nutrient solution can change considerably as it flows down into containers positioned at successively lower vertical levels of such planters. In a vertical stack of five containers, as much as a three point difference in pH between the solution introduced into the top container and that recovered from the bottom container has been observed, presumably as a result of each successive root ball absorbing free hydrogen ions. This observation has significant horticultural implications since the ability of plants to take up various nutrients, such as iron for example, is highly dependent on the pH of the nutrient solution.

Another significant disadvantage of planters of the type in which fluid flows successively from higher containers to lower ones and/or where more than one plant is planted in a common body of growing media is that insect infestations, fungi or other plant diseases tend to spread easily and rapidly.

### SUMMARY OF THE INVENTION

According to a preferred embodiment, a freestanding vertical horticultural apparatus for commercial and/or home use for growing plants includes a plurality of growing containers which are arranged in two or more mutually vertically spaced groups. A hollow inner spindle supports, and is rotatably coupled to, a co-axial outer tube. Each group of containers is removably mounted in brackets which are mechanically coupled to the outer tube so that each group of containers may rotate in synchrony with one another about the common longitudinal axis of the spindle and the outer tube to facilitate plant care and harvesting as well as to permit reduction of unproductive aisle space between rows or columns of the apparatuses, thereby increasing overall yield per unit of available area.

A pressurized fluid supply line routed through the interior of the hollow inner spindle is coupled to a spray emitter by way of a flow control valve. At a flow rate determined by the flow control valve, the emitter sprays irrigation fluid, preferably in a uniform three hundred sixty degree (360°) spray pattern inside a hollow distributor body which is positioned at the top of the apparatus. The interior of the distributor body is segmented into a plurality of fluid collection zones of substantially equal size, shape and volume. The emitter emits a substantially equal volume flow rate of fluid into each fluid collection zone. The bottom of each fluid collection zone terminates in a sump. A discharge port at the base of each respective sump is coupled by way of a fluid distribution tube to a respective one of the containers. This arrangement assures that each sump, and therefore ultimately each growing container, receives substantially the same amount of fluid per unit of time, even if the apparatus is mounted so that the common longitudinal axis of the inner spindle and the outer tube deviates somewhat from vertical. The invention thus provides a freestanding horticultural apparatus for growing plants in a plurality of mutually vertically spaced groups of containers in which each container receives a substantially uniform flow rate of irrigation fluid such as water, either with or without dissolved or undissolved plant nutrients.

Since irrigation fluid is supplied to each sump at a flow rate which is selectable or adjustable via the flow adjustment valve which precedes the emitter in the flow path, each growing container in the apparatus can receive substantially the same amount of fluid per unit of time even though the containers of different groups lie at different elevations and or different distances from the supply of pressurized irrigation fluid. Moreover, in installations involving two or more apparatuses, those apparatuses may be located at substantially different base elevations and/or substantial distances apart. As long as the fluid supply pressure is at least sufficient to provide an adequate flow rate to the containers in the apparatus which is located at the highest base elevation and/or most remote from the pressurized fluid supply or for any other reason has the lowest fluid pressure of any of the apparatuses in the installation, all of the containers of all of the apparatuses in the installation can be set or adjusted to receive substantially the same amount of fluid per unit of time by adjusting their flow control valves accordingly. Thus, the invention provides a horticultural apparatus for growing plants in a plurality of mutually vertically spaced groups of containers wherein irrigation fluid is supplied to the containers under static pressure developed by accumulation of fluid sprayed inside the apparatus but is delivered to the apparatus under higher pressure, the flow rate of fluid delivered to the containers being selectable or adjustable by a flow adjustment valve interposed between the higher pressure fluid supply and the emitter which sprays the fluid inside the apparatus.

The bottom of each growing container preferably has a drain opening beneath which is located a drainage re-director for receiving and discharging any excess irrigation fluid. To reduce the risk of spreading disease or insect infestations or otherwise damaging underlying foliage, each drainage re-director is preferably oriented to discharge fluid to a location which will cause the fluid to fall along a path which does not intersect any underlying growing containers or foliage. Since fluid does not pass through one container before irrigating another, each container receives fluid of the same pH and nutrient concentration. Moreover, each container receives the same amount of fluid per unit of time irrespective of the degree of absorbency of the growing media used.

To help protect plant root systems from transient fluctuations in ambient temperatures, the containers are preferably constructed with thermally insulated walls. The containers could suitably be formed of expanded polystyrene foam but are more preferably of a double wall construction in which an inner shell is joined to an outer shell in such a way as to provide an insulating interior space between the inner shell and the outer shell.

The foregoing and other aspects and advantages of the invention will become apparent in view of the following detailed description and the appended drawings in which like reference numerals are used to designate like items.

### BRIEF DESCRIPTION OF THE DRAWINGS

FIG. 1 is a perspective view illustrating a preferred embodiment of a horticultural apparatus according to the invention.

FIG. 2 is a sectional view taken along line 2-2 of FIG. 1;

FIG. 3 is a top plan view of one of the brackets shown in FIG. 1, the bottom plan view of the bracket being identical thereto;

FIG. 4 is a top plan view of a bracket support collar;

FIG. 5 is a sectional view taken along line 5-5 of FIG. 2;

FIG. 6 is an enlarged view of the upper portion of FIG. 2;

FIG. 7 is an enlarged view of the lower portion of FIG. 2;

FIG. 8 is a schematic diagram illustrating a preferred arrangement of a plurality of horticultural apparatuses according to a further aspect of the invention.

### DETAILED DESCRIPTION OF PREFERRED EMBODIMENTS

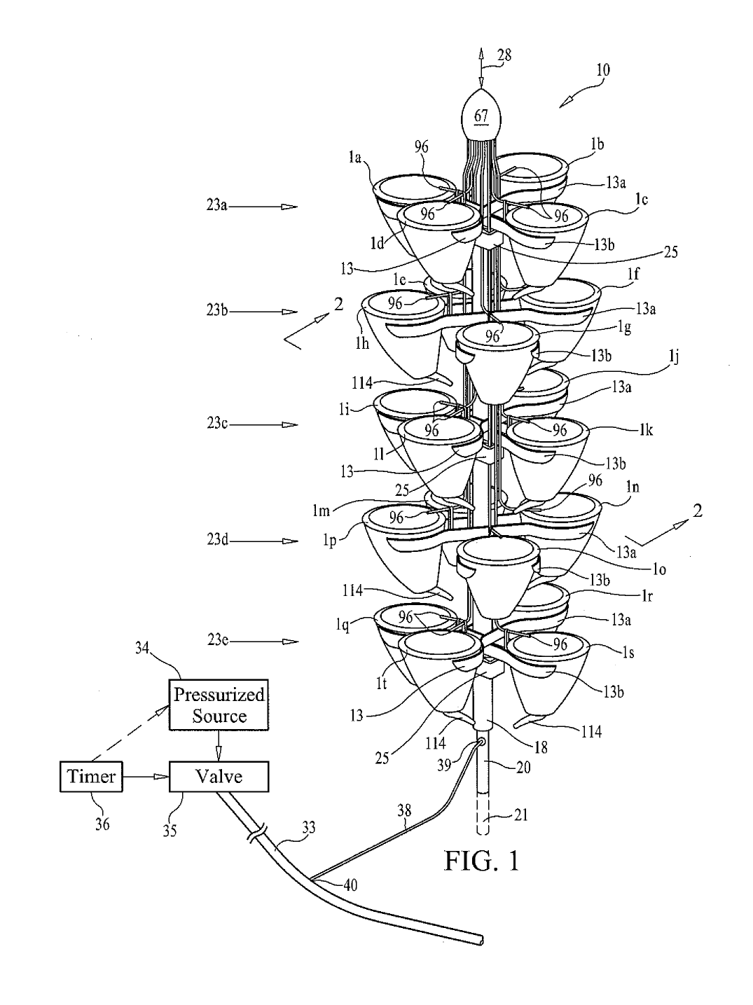

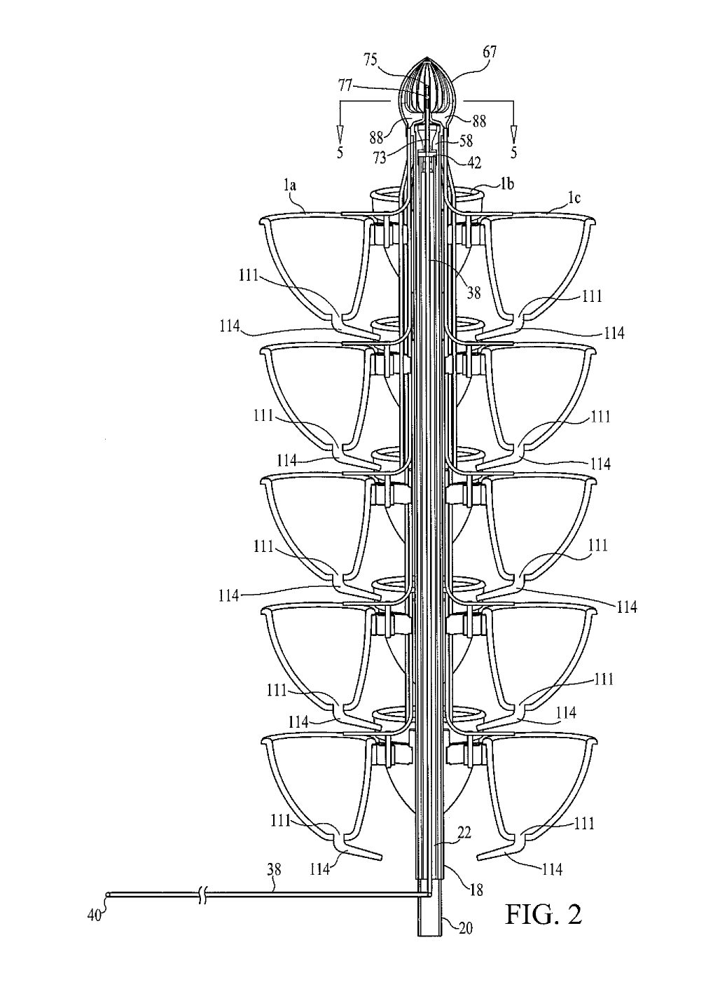

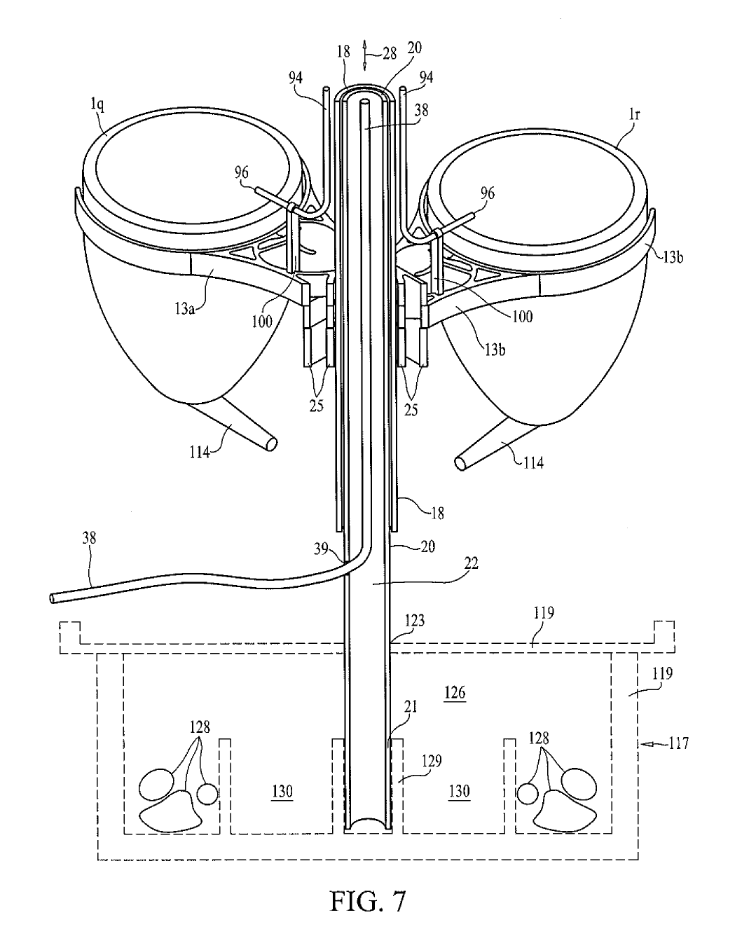

Referring initially to FIGS. 1 and 2, a preferred embodiment of a horticultural apparatus 10 according to the invention has a plurality of identical growing containers 1a through 1t, which are removably mounted in brackets 13. Brackets 13 which are secured to an elongated tubular outer tube 18 which may comprise, for example, a length of three quarter inch inside diameter (¾ in. i.d.) Schedule 40 polyvinyl chloride (PVC) pipe. Outer tube 18 is rotatably supported by a substantially vertically mounted elongated hollow spindle 20 having an elongated interior space 22. By way of example, hollow inner spindle 20 may suitably comprise a length of galvanized metal electrical conduit one-half inch inside diameter (½ in. i.d.). To support the apparatus 10, the lower end 21 of the hollow spindle 20 may either be driven directly into the ground as indicated by the phantom lines in FIG. 1, or may optionally be received into an optional mounting base as will be described in further detail below with reference to FIG. 7.

In the illustrated embodiment, there are, by way of example, five (5 ea.) mutually vertically spaced groups 23a, 23b, 23c, 23d and 23e of containers 1, each group 23 having of four (4 ea.) containers 1. Each group 23a, 23b, 23c, 23d and 23e of containers 1 is removably held by one of a pair of mating brackets 13 which are supportably mounted to outer tube 18. It is to be understood that a fewer or greater number of groups 23 and/or containers 1 per group 23 could alternatively be used. An upper bracket 13a holds two growing containers 1 of each group and a lower bracket 13b, whose structure is preferably substantially identical to that of the upper bracket 13a, holds the remaining two growing containers 1 of each group 23.

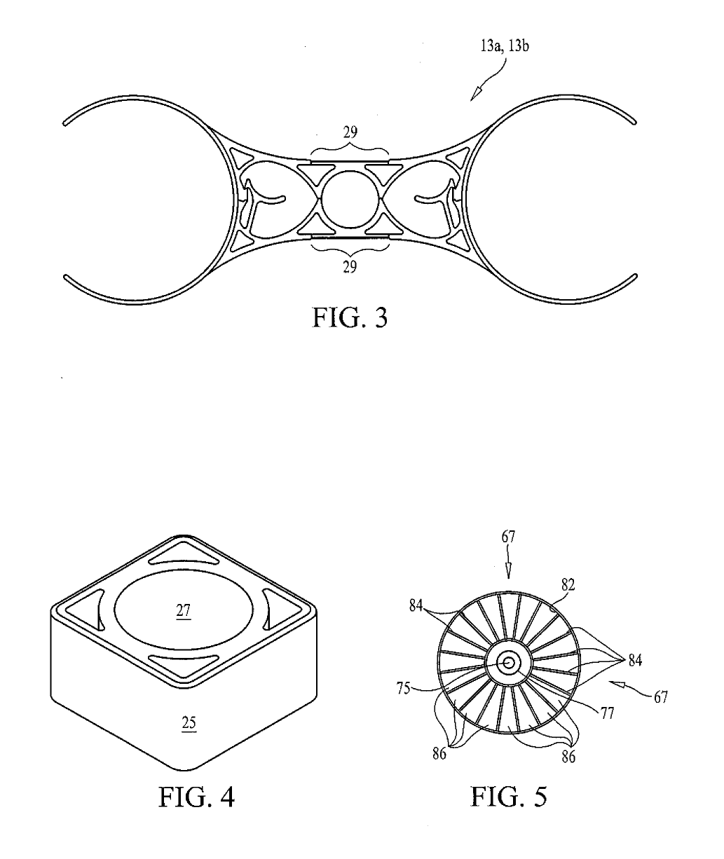

The growing containers 1 in each group 23a-23e are preferably disposed at substantially equally angularly spaced intervals in a generally circular array which is substantially centered around the longitudinal axis 28 of the outer pipe 18 in order to provide substantially even circumferential weight distribution. As shown in FIG. 3, the upper brackets 13a and lower brackets 13b are preferably identical to one another and preferably include surface features 29 which allow the upper bracket 13a to rest on, and mate with, the lower bracket 13b so as to maintain a fixed angular offset between the two brackets 13a, 13b of each vertically adjacent group 23a-23e.

Each group 23a-23e of growing containers 1 and their respective upper and lower brackets 13a, 13b are supportably mounted to the outer tube 18 by way of a respective bracket support collar 25 which is mounted to the outer tube 18 beneath the lower bracket 13. As illustrated in FIG. 4, the bracket support collar 25 has a central aperture 27 which is sized to provide a slip fit over the exterior surface of the outer tube 18. Each bracket support collar 25 may be adjustably positioned along the longitudinal axis 28 of the outer tube and clamped to the exterior surface of the outer tube 18 at a desired elevation by way of a set screw (not shown), which passes through a threaded hole in the wall of the bracket support collar 25 and engages the exterior surface of the outer tube 18 when tightened. Loosening the set screw allows the position of brackets 13 to be angularly or longitudinally adjusted and provides for easy removal of brackets 13, allowing apparatus 10 to be at least partially disassembled for compact storage when not in use. Alternatively, the bracket support collar 25 can be chemically welded, adhesively attached or otherwise non-removably attached to the outer tube 18. Each upper bracket 13a rests on and is supported by a lower bracket 13b which in turn rests on and is supported by a bracket support collar 25.

The underside of each bracket support collar 25 has one or more surface features 29, such as recesses and/or projections, which are physically mateable with complementary surface features of lower bracket 13 in order to hold the lower bracket 13 at a fixed angular position relative to the bracket support collar 25, and thus the outer tube 18. To maximize available growing space for plants, the bracket support collars 25 are preferably angularly positioned such that each group 23 of containers 1 is at least partially angularly offset from each elevationally adjacent group 23.

A pressurized fluid supply line 33, which may suitably take the form of a one-half inch inside diameter (½ in. i.d.) polyethylene irrigation tubing, receives fluid under pressure from either a faucet (not shown), a tank 35 which is sufficiently elevated to provide adequate fluid pressure or, a tank 35 coupled to a pump. This larger diameter supply line 33 may serve as a manifold for supplying fluid to one or more apparatuses 10. Apparatus 10 includes a length of tubing 38, such as one-quarter inch inside diameter (¼ in. i.d.) flexible polyethylene irrigation tubing, which passes through an opening 39 in a lower portion of the wall of the hollow spindle 20 into the hollow interior space 22 of the spindle 20 and extends upward through the interior space 22 of the spindle 20 to a location adjacent the upper end of spindle 20. A lower portion of the tubing 38 extends exteriorly from the outer tube 18 a distance sufficient to allow its distal end 40 to be coupled directly to the pressurized fluid supply line 33 to form a fluid-tight connection therewith in a manner well known in the art.

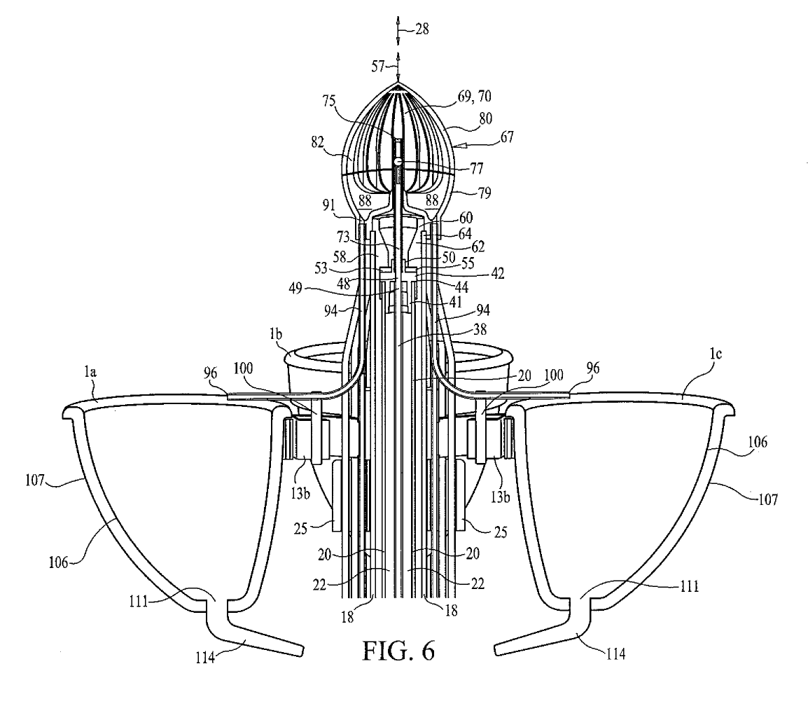

As most clearly seen in FIG. 6, tubing 38 is connected to the lower end 41 of a coupler cap 42 which is mounted to the upper end of the spindle 20. The coupler cap 42 has an annular shoulder 44 which rests supportably on the upper end of the spindle 20 while the reduced diameter lower end 41 of coupler cap 42 is press-fitted into the upper end of spindle 20. The coupler cap 42 includes central fluid passageway 48 to which the proximal end 49 of the pressurized fluid supply tubing 38 is connected in a fluid-tight manner. The upper end of the coupler cap 42 has a female fluid connector 50 whose base is surrounded by an annular shoulder 53. A plastic washer 55 is positioned on top of the annular shoulder 53 of the coupler cap 42 to serve as a low friction thrust bearing to allow the outer tube 18, and the components fixed relative thereto, to rotate relatively freely about the longitudinal axis 57 of the spindle 20 which is substantially co-axial with the longitudinal axis 28 of the outer tube 18. Plastic washer 55 may suitably be formed of an acetyl resin such as that distributed under the trademark DELRIN® which is a registered trademark of E.I. du Pont de Nemours and Company. If desired, the interface between annular shoulder 53 and plastic washer 55 may be lubricated with any suitable lubricant, such as, for example, graphite powder or more preferably, silicone grease.

The upper end 64 of the outer tube 18 is fitted with an end fitting 58 which has an upper rim 60 and a reduced diameter portion 62 which is secured to the inside wall of the outer tube 18 such that the upper rim 60 of the end fitting 58 rests upon the upper end 64 of the outer tube 18. Also attached to the upper end 64 of the outer tube 18 is a hollow distributor body 67 whose interior 69 forms a fluid distribution chamber 70 which is preferably substantially fully enclosed, except perhaps for one or more optional small pressure vent holes (not shown), to reduce loss of irrigation fluid due to evaporation or overspray and reduce the risk of debris, insects or other external contaminants from entering the fluid distribution chamber 70.

A hollow riser tube 73 extends from the female fluid connector 50 on the upper end of the coupler cap 42 into the distribution chamber 70 of the distributor body 67 where the upper end of the riser tube 73 is coupled to a three hundred sixty degree (360°) degree fluid spray emitter 75 (i.e. a spray head which emits a substantially circular spray pattern) by way of a flow adjustment valve 77 which is interposed between fluid emitter 75 and pressurized riser tube 73. To facilitate access to the flow adjustment valve 77, the distributor body 67 is preferably of bipartite form, having a lower housing 79 which can be permanently attached to the outer tube 18 and an upper housing 80 which attaches, preferably removably, to the lower housing 79 by way of a snap fitted connection as illustrated or a threaded connection (not shown). The upper housing 80 and lower housing 79 of the distributor body 67 are preferably opaque, or are at least substantially opaque, so as to inhibit the growth of algae and the like inside the fluid distribution chamber 70. To inhibit growth of bacteria and fungi within fluid distribution chamber 70 the upper housing 80 and lower housing 79 of the distributor body 67 may optionally be formed of and/or coated with, a material with anti-microbial and/or anti-fungal properties.

It is to be noted that no portion of the pressurized fluid flow path inside the apparatus 10 requires use of a fluid-tight rotatable union since in use, outer tube 18 and the structures rotatably affixed thereto such as fluid distribution cap 67, brackets 13a and 13b as well as containers 1a through 1t are all free to rotate relative to spindle 20 about common axis 28, 57 without effecting relative rotation between any of: the fluid emitter 75, the flow adjustment valve 77, the riser tube 73, the spindle 20, the coupler cap 42 and/or the fluid supply tube 38.

As can be most clearly seen from FIGS. 5 and 6, projecting radially inwardly from the inside wall 82 of distributor body 67 are a plurality partitions 84 which subdivide the fluid distribution chamber 70 into a plurality of discrete segmental fluid collection zones 86. The number of fluid collection zones preferably, but not necessarily, corresponds to the total number of growing containers 1, in the apparatus 10. The lower portions of the partitions are of sufficient height to form a sump 88 at the base of each fluid collection zone 86. Each of the sumps 88 is preferably dimensioned to be capable of holding substantially the same volume of irrigation fluid. Preferably, the sumps 88 are dimensioned to hold at least a volume of irrigation fluid adequate to produce a static pressure sufficient to overcome whatever downstream flow resistance that could otherwise inhibit the draining of irrigation fluid from the sumps 88.

Located at the base of each sump 88 is a discharge port 91 which is coupled to a respective fluid delivery tube 94, each of which is routed to discharge into a respective one of the growing containers 1. Each discharge end 96 is preferably fitted with a bug screen (not shown) of a conventional type to inhibit insect intrusion into the fluid delivery tube 94. To prevent dislocation of its discharge end 96, a terminal portion 48 of each fluid delivery tube 94 is detachably retained by a support clamp 100 which is clipped or otherwise suitably to an upper bracket 13a or a lower bracket 13b, as the case may be. In addition, tubing clamps (not shown) of substantially “C”-shaped cross section are preferably removably clipped onto the outer tube 18 at various locations to hold vertically running portions of the fluid delivery tubes 94 substantially parallel to one another to provide a neat appearance and help prevent the fluid delivery tubes 94 from becoming entangled in plants present in the growing containers 1, when the apparatus 10 is in use.

As previously noted, the distributor body 67 may optionally be vented to atmosphere by way of one or more vent openings (not shown) fully penetrating the upper housing 80 of the distributor body 67. Such vent openings are not essential, however. Even without vent openings, the interior 69 of the distributor body 67 will not rise significantly above atmospheric pressure provided the total volume flow rate of fluid which can be discharged from the sumps 88 in aggregate under gravity exceeds, or at least equals, the maximum volume flow rate of fluid discharged into the interior of the distributor body 67 by fluid emitter 75 under normal operating conditions.

The growing containers 1 may suitably be formed to have a single wall of expanded polystyrene foam but are more preferably of a double wall construction formed as an inner shell 106 joined to an outer shell 107 in such a way as to provide a thermally insulating interior space 108 between the inner shell 106 and the outer shell 107. The interior space 108 may either be filled with a gas or gas mixture such as air or may be at least partially evacuated. Such constructions help to reduce heat transfer across the wall of the growing container 1 to help provide a more stable thermal environment for the roots of plants growing in the containers 1. The outer shell 107 and the inner shell 106 may be joined together by ultrasonic welding, heat sealing, adhesive bonding, solvent bonding or any other suitable technique. Alternatively, outer shell 107 and inner shell 106 may be fabricated as a unitary structure by a process such as rotary molding.

The bottom of each growing container 1 is provided with a drain opening 111 beneath which is located a drainage re-director 114 which is preferably oriented to discharge any irrigation fluid it may receive to a location which will cause the fluid to fall along a path which does not intersect any underlying growing containers 1 and preferably intersects little or no foliage.

In lieu of anchoring the lower portion 21 of spindle 20 in the ground as shown in FIG. 1, the lower portion 21 may optionally be received in a mounting base 117. A suitable mounting base 117 may for example take the form of a simple block of concrete or stone (not shown) which has a socket or recess for receiving the lower end 21 of hollow spindle 20 and is of sufficient mass to allow apparatus 10 as a whole to be freestanding. Alternatively, as shown in FIG. 7 a suitable mounting base 117 can be formed as a metal or plastic container 119 having a lid 121 with a central aperture 123 for receiving the lower end 21 of the hollow spindle 20. Such a mounting base 117 may include a hollow interior 126 to hold a sufficiently heavy quantity of sand, rocks, gravel, water or other suitable ballast material 128 and a socket 129 for holding the lower end 12 of spindle 20. The hollow interior 126 of the mounting base 117 may also include one or more receptacle(s) 130 to capture and hold for recycling, any irrigation fluid which may drip onto the lid 121 of the mounting base 117. If a mounting base of the type schematically illustrated in FIG. 7 is used, the drainage re-directors 114 are preferably oriented and sized to cause such fluid to fall onto the lid 121 of the mounting base 117. The lid 121 of the mounting base 117 is preferably faulted of a porous non-woven plastic mat which allows liquid to pass through, with little loss due to splashing, and be collected in the receptacle(s) 130 inside the mounting base 117. Alternatively, lid 119 may be formed as a generally solid structure provided with one or more openings to allow irrigation fluid to pass through.

In operation, an irrigation fluid such as for example, water or a solution or a mixture of water and one or more dissolved or undissolved plant nutrients or other beneficial agents, referred to herein as “irrigation fluid”, is introduced under pressure into the supply line 33 from a pressurized source 34. The fluid enters supply tube 38 from the supply line 33 and flows upward by way of a flow path at least a portion of which passes interiorly through the interior space 22 of tube spindle 20. Under pressure, the irrigation fluid passes through the fluid supply tube 38, coupler cap 42, riser tube 73 and flow adjustment valve 77 and is discharged under pressure from the fluid emitter 75, preferably in a substantially uniform three hundred and sixty degree (360°) degree spray pattern. The upper housing 80 of the distributor body 67 may optionally be temporarily removed to permit inspection and/or cleaning of the fluid emitter 75 and/or setting of the flow rate by adjusting the flow adjustment valve 77. After the upper housing 80 of the distributor body 67 is replaced, the fluid discharged from the emitter 75 strikes the inside wall 82 of the distributor body 67 and is channeled by partitions 84 into the sumps 88. The partitions 84 of the distributor body 67 help assure that each sump 88 receives fluid at a volume flow rate which is substantially equal to that of the other sumps 88, thereby assuring that each growing container 1 receives substantially the same volume of fluid per interval of time.

Fluid initially accumulates in each sump 88 until the volume of fluid present generates sufficient static pressure to overcome surface tension, or other resistance to flow, to allow fluid to flow by gravity from the discharge port 91 at the bottom of the sump 88 and into a respective growing container 1 by way of the respective fluid delivery tube 94 that is coupled to the discharge port 91 of the sump 88.

The flow of fluid into each of the growing containers 1 continues until being terminated by exhaustion of the irrigation fluid supply or by cutting off pressurized flow of fluid into the fluid supply tube 33 from the pressurized source 34 such as by closing a valve 35 and/or shutting off a pump (not shown) located upstream of the apparatus 10. In a typical installation, the valve 35 and/or the pressurized source 34 of irrigation fluid will be controlled by a timer 36, so that preferably, both the time and duration of introduction of pressurized irrigation fluid into apparatus 10 can both be adjustably set via the timer 36.

A significant advantage of an apparatus 10 of the type described above is that the growing containers 1 of a plurality of apparatuses 10 stationed on terrain at different elevational levels, and/or at distances sufficient to induce significant reductions in pressure due to the flow resistance associated with the pressurized supply line 33 can all be supplied from a common source of pressurized fluid and still supply their respective growing containers 1 with substantially equal amounts of fluid provided the pressure is sufficient to deliver fluid at substantially the desired flow rate from the fluid emitters 75 of the apparatuses 10 which are stationed at the highest elevation and/or most distant from the fluid source as measured along the fluid flow path to the apparatuses 10. The flow adjustment valves 77 of the apparatuses 10 located closer to the source and/or at lower elevations can be throttled so that the fluid emitters 75 of each of them emits fluid at substantially the desired flow rate. As long as the flow rates of fluid discharged from the emitters 75 of all the apparatuses 10 supplied by common source of pressurized fluid are substantially equal, the levels of fluid in the sumps 88 will also tend to be substantially equal as will the static pressure heads present at the discharge port 81 of each sump 88, regardless of their elevation above sea level or their distance from the source of pressurized fluid. Since the rate of flow of fluid delivered to a given growing container 1 will be determined mainly by the static pressure head at the discharge port 91 of the sump supplying that growing container, the flow rates of fluid to each of the growing containers 1 will also be substantially equal.

From the foregoing description of the apparatus 10, it will also be apparent that the exterior components of the apparatus 10, including the brackets 13a, 13b, the fluid delivery tubes 94 and the containers 1 are rotatable in synchrony with one another about the inner spindle 20 and that in the preferred embodiment, the fluid emitter 75, the flow adjustment valve 77, the riser tube 73, the coupler cap 42, and the fluid supply tube 38 do not rotate relative to one another or relative to the spindle 20. Thus, at any time before and/or after and/or during the delivery of fluid into the growing containers 1, the groups 23a-23e of growing containers 1 can be rotated in synchrony with one another about the longitudinal axis 57 of the spindle 20. This allows a person located next to the apparatus 10 to have direct access to all of the growing containers 1 in the apparatus and their contents without having to either walk around the apparatus 10, or reach around or through the apparatus 10. This feature provides significant benefits.

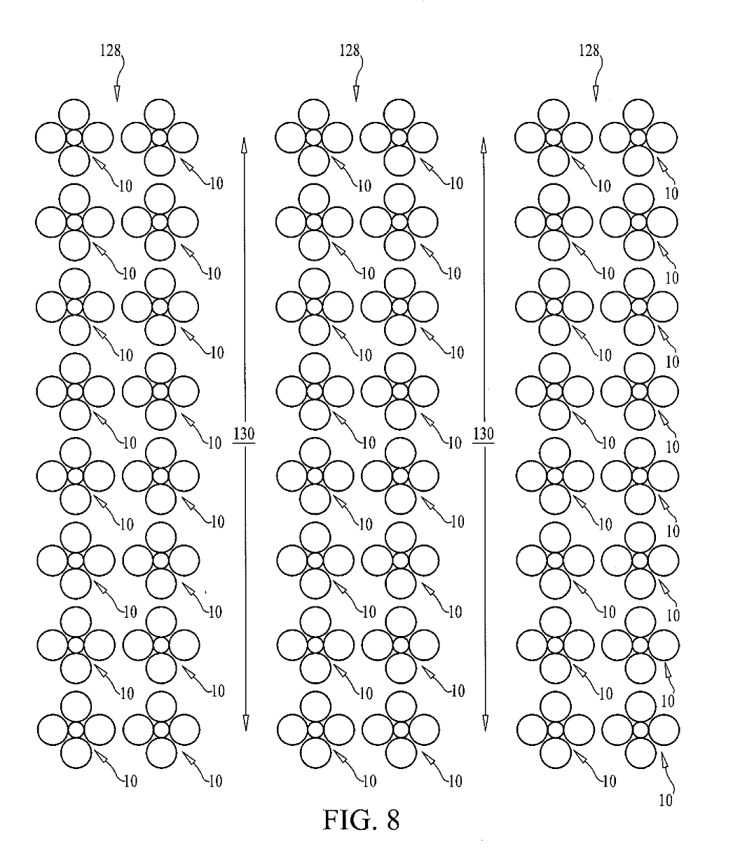

By reducing the walking and/or extended reaching needed to access all the containers 1 in a given apparatus 10, tasks such as planting, tending and harvesting from plants planted in the growing containers 1 can be performed more easily, with less damage to the plants and less risk of cross-contaminating plants due to transfer of insects or diseases. Further, by arranging a plurality of apparatuses 10 in a series of mutually-spaced elongated linear arrays made up of pairs of rotatable apparatuses 10 as shown in FIG. 8 the total amount of space needed for aisles can be significantly reduced, thereby increasing overall production per acre, or in the case of indoor plant production, per unit of floor space.

Also, the growing containers 1 can easily be rotated to assure that, on average, all of the plants receive substantially the same average sun exposure over time. Such rotation could be performed for example by manually rotating each individual apparatus 10 from time to time at such times as the grower might consider appropriate. Rotation could also be carried out with the aid of an electric motor drive unit attached to each apparatus 10. For example a permanent magnet D.C. motor could be coupled to the outer pipe by way of a simple gear train, with electrical power being supplied either from an AC to DC converter, a solar panel, a storage battery or a combination or subcombination thereof. Alternatively, the outer tubes 18 of two or more apparatuses 10 could be driveably coupled in common to an elongated flexible driving device, such as a cable, belt or chain engageable with a sheave, drum or sprocket driveably coupled to the outer tube 18 of each apparatus 10.

A preferred embodiment of a horticultural method of the invention, namely, a method for irrigating a plurality of planting containers according to the invention, may include the steps which will now be described. A plurality of containers are non-suspendably supported in groups arranged about a substantially vertical axis of an elongated support member, each of the groups being mutually spaced from one another along the axis. Optionally but preferably, the containers are supported such that they may orbit at least partially around, and preferably completely around, the substantially vertical axis. Irrigation fluid is sprayed into the interior of a substantially enclosed distributor body which is supported by the aforementioned elongated member. Optionally but preferably, the interior of the distributor body is subdivided into a plurality of fluid collection zones, each of which terminates in a respective sump. Optionally but preferably, the irrigation fluid for carrying out the spraying is delivered to a spray emitter located inside the distributor body by way of a flow path which passes through at least a portion of the interior of the elongated support member. Irrigation fluid collected in each respective sump of each fluid collection zone is conducted to each respective one of the containers. Optionally but preferably, at least one of the containers, and more preferably, substantially all of the containers, are provided with a drain opening and any irrigation fluid which may exit the drain opening is redirected to follow along a path which does not intersect any of the other containers. Optionally but preferably, the flow rate of the irrigation fluid sprayed into the distributor body, is adjusted or set using a valve which is mechanically coupled to the distributor body and, is optionally but preferably located inside the distributor body. Alternatively, the flow adjustment valve could be located anywhere upstream of the fluid emitter, but for best control, the valve should be located flow-wise as closely proximate the fluid emitter as practicable.

While the invention has been described with reference to certain preferred embodiments, it should be understood by those skilled in the art that various changes may be made and equivalents substituted for elements thereof without departing from the scope of the invention. In addition, many modifications may be made to adapt a particular situation or material to the teachings of the invention without departing from the essential scope thereof. Therefore, it is intended that the invention not be limited to the particular embodiments disclosed as the best mode contemplated for carrying out this invention, but that the invention will include all embodiments falling within the scope of the appended claims, either literally or under the doctrine of equivalents.

What is claimed is:

1. A horticultural apparatus, comprising:
an elongated hollow tube having a longitudinal axis;
at least two groups of planting containers supported by brackets, said brackets being attached to said hollow tube, each of said groups being mutually spaced from one another along said axis, each of said containers being located to receive fluid discharged from a discharge end of a respective one of a plurality of fluid delivery tubes, each of said fluid delivery tubes also having an intake end;
a hollow distributor body whose interior forms a substantially enclosed fluid distribution chamber which is segmented into a plurality of fluid collection zones each of which terminates in a sump, each said sump being coupled to a said intake end of a respective one of said fluid delivery tubes, and;
a fluid emitter coupleable to a pressurized source of irrigation fluid, said fluid emitter being disposed in said fluid distribution chamber for emitting fluid into each respective one of said fluid collection zones at substantially equal flow rates.

2. A horticultural apparatus as claimed in claim 1, further comprising a flow control valve connected in series between said pressurized source of irrigation fluid and said fluid emitter for setting or adjusting the flow rate of irrigation fluid sprayed by said emitter into said fluid collection zones.

3. A horticultural apparatus as claimed in claim 1 or claim 2 wherein said fluid emitter is coupled to said pressurized source of irrigation fluid by way of a flow path at least a portion of which passes interiorly through at least a portion of said hollow spindle.

4. A horticultural apparatus as claimed in claim 2, wherein said flow control valve is mounted inside said fluid distribution chamber.

5. A horticultural apparatus as claimed in claim 1 or claim 4, further comprising an elongated hollow spindle upon which said elongated hollow tube is supported and is rotatably mounted to permit rotation of said hollow tube, said distributor body, said brackets and said containers about said axis relative to said hollow spindle and said fluid emitter.

6. A horticultural apparatus as claimed in claim 4 or claim 5 wherein said fluid emitter is coupled to said pressurized source of irrigation fluid by way of a flow path at least a portion of which passes interiorly through at least a portion of said hollow spindle.

7. A horticultural apparatus as claimed in claim 1 or claim 5 wherein at least one of said containers includes a drain opening and a fluid redirector at least a portion of which is located beneath said drain opening to redirect any of said irrigation fluid which may exit said drain opening to fall along a path which does not intersect any other of the containers.

8. A horticultural method, namely a method for irrigating a plurality of plant containers, said method comprising the steps of:
supporting the containers in groups arranged about a substantially vertical axis of an elongated support member, each of said groups being mutually spaced from one another along said axis;
spraying irrigation fluid into the interior of a substantially enclosed distributor body which is supported by said support member, said interior being subdivided into a plurality of fluid collection zones each of which terminates in a respective sump; and
conducting irrigation fluid collected in each respective sump to each respective one of said containers.

9. A method as claimed in claim 8, wherein said supporting step comprises the step of rotatably supporting the containers such that they may orbit about said axis.

10. A method as claimed in claim 8 or claim 9, wherein said irrigation fluid for carrying out said spraying step is delivered to a spray emitter by way of a flow path which passes through at least a portion of an interior portion of said elongated support member.

11. A method as claimed in claim 8, claim 9 or claim 10, further comprising the steps of
providing at least one of the containers with a drain opening, and
redirecting any of said irrigation fluid which may exit said drain opening to fall along a path which does not intersect any other of the containers.

12. A method as claimed in claim 8, claim 9, claim 10 or claim 11, further comprising the step of:
adjusting or setting a flow rate of irrigation fluid sprayed in said spraying step using a valve which is coupled to said distributor body.

13. A method as claimed in claim 12, wherein said valve is located inside said distributor body.

14. A method comprising the step of:
arranging a plurality of horticultural apparatuses in an array, said array being comprised of a plurality of horticultural apparatuses disposed in a plurality of columns, mutually adjacent ones of said columns being separated by one of a plurality of aisles, each of said columns being comprised of multiple pairs of said horticultural apparatuses arranged linearly and being at least one of said pairs in width, each of said horticultural apparatuses being non-suspendably supported and bearing a plurality of planting containers which are rotatably mounted to orbit a central axis. supporting the containers in groups arranged about a substantially vertical axis of an elongated support member, each of said groups being mutually spaced from one another along said axis;
spraying irrigation fluid into the interior of a substantially enclosed distributor body which is supported by said support member, said interior being subdivided into a plurality of fluid collection zones each of which terminates in a respective sump; and
conducting irrigation fluid collected in each respective sump to each respective one of said containers.

15. A method as claimed in claim 14 wherein said supporting step comprises the step of rotatably supporting the containers such that they may orbit about said axis.

16. A method as claimed in claim 14 wherein said irrigation fluid for carrying out said spraying step is delivered to a spray emitter by way of a flow path which passes through at least a portion of an interior portion of said elongated support member.

17. A method as claimed in claim 14, further comprising the steps of:
providing at least one of the containers with a drain opening, and
redirecting any of said irrigation fluid which may exit said drain opening to fall along a path which does not intersect any other of the containers.

18. A method as claimed in claim 14, further comprising the step of:
adjusting or setting a flow rate of irrigation fluid sprayed in said spraying step using a valve which is coupled to said distributor body.

19. A method as claimed in claim 18, wherein said valve is located inside said distributor body.
